(19) United States
(12) Patent Application Publication
(10) Pub. No.: US 2016/0307436 A1
(43) Pub. Date: Oct. 20, 2016

(54) Emergency Safety Monitoring System and Method

(71) Applicant: Monty Nixon, Woodbridge, VA (US)

(72) Inventor: Monty Nixon, Woodbridge, VA (US)

(21) Appl. No.: 15/193,833

(22) Filed: Jun. 27, 2016

Related U.S. Application Data
(60) Provisional application No. 62/198,819, filed on Jul. 30, 2015.

(51) Int. Cl. G08B 25/01; H04N 5/232; G10L 15/22; H04N 7/18

(52) U.S. Cl. CPC G08B 25/016; H04N 7/185; H04N 5/23203; G10L 15/22; G10L 2015/223

(57) ABSTRACT

An emergency safety and monitoring system. The emergency safety and monitoring system includes a wearable device, such as a bracelet or a key ring, having an actuatable button that sends a command activating an audiovisual recording mechanism that can capture audiovisual data on an electronic device. The command also causes a GPS receiver to record location information about the electronic device. After a predetermined amount of time, the captured audiovisual data and location information is communicated to a remote server, emergency personal, or preselected individuals. In one embodiment, the command causes the electronic device to send an emergency message, such as an SMS text message.

### CROSS REFERENCE TO RELATED APPLICATION

This application claims the benefit of U.S. Provisional Application No. 62/198,819 filed on Jul. 30, 2015. The above identified patent application is herein incorporated by reference in its entirety to provide continuity of disclosure.

### BACKGROUND OF THE INVENTION

The present invention relates to an emergency safety monitoring system and method. More specifically, the present invention relates to a system and method that utilizes an electronic device that is configured to receive a command by a wearable device, wherein the electronic device comprises an audiovisual recording mechanism configured to capture audiovisual data.

Mobile and cell phone ownership has risen over the years where about 90% of American adults have adopted this consumer technology. Mobile phones have altered the way people communicate with each other, and assisted with the creation of a communication network that provides for almost instantaneous connection between persons. Thus, these mobile phones and other similar mobile devices have changed how many situations are handled, including emergency situations. However, during an emergency situation it is often difficult or impossible for a person to reach out to others for assistance. The individual may not have access to a mobile phone or otherwise not have the ability to utilize the communication features of the electronic device, such as an audiovisual communication mechanism. Further, if an individual is isolated, it can also be difficult to provide evidence or proof that a certain event actually occurred.

Many electronic devices utilize audiovisual mechanism such as cameras and microphones to capture and record audiovisual data at the direction of a user. Typically, these electronic devices are activated and controlled by interacting with a touchscreen, where the audiovisual data is stored on electronic device. However, these electronic devices, for example, do not allow for the activation, capture, and communication of audiovisual data such as short message service (SMS) upon receiving a command.

In light of the devices disclosed in the known art, it is submitted that the present invention substantially diverges in design elements from the known art and consequently it is clear that there is a need in the art for an improvement to emergency safety monitoring systems and methods. In this regard the instant invention substantially fulfills these needs.

### SUMMARY OF THE INVENTION

In view of the foregoing disadvantages inherent in the known types of emergency safety monitoring systems and methods now present in the known art, the present invention provides an emergency monitoring system and method that utilizes an electronic device, wherein upon receiving a command, captures audiovisual data and location information and transmits this information to a remote storage device.

It is therefore an object of the present invention to provide a new and improved emergency monitoring system and method that has all of the advantages of the known art and none of the disadvantages.

The present invention relates to an emergency monitoring system and method comprising an electronic device in wireless communication with a wearable device, which causes the electronic device to capture audiovisual data and location information.

It is another object of the present invention to provide an emergency monitoring system and method that transmits the captured audiovisual data and location information to a remote server, such as a remote storage device, cloud storage system, or the like.

It is a further object of the present invention to provide an emergency monitoring system and method wherein the wearable device is attachable containing a loop configured to connect to a wearer's keychain belt loop or a bracelet configured to encircle the wrist of a wearer having an actuatable buttons for communicating with the electronic device.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows one embodiment of the emergency monitoring system in accordance to the present invention.

FIG. 2 shows a block diagram of one embodiment of an electronic device in accordance with an exemplary embodiment of the present invention.

FIG. 3 shows an exemplary flowchart of one process used to implement the emergency monitoring system and method provided by the present invention.

### DETAILED DESCRIPTION OF THE INVENTION

Reference is made herein to the attached drawings. Like reference numerals are used throughout the drawings to depict like or similar elements of the emergency monitoring system and method. For the purposes of presenting a brief and clear description of the present invention, the preferred embodiment will be discussed as used for monitoring an emergency situation. The figures are intended for representative purposes only and should not be considered to be limiting in any respect.

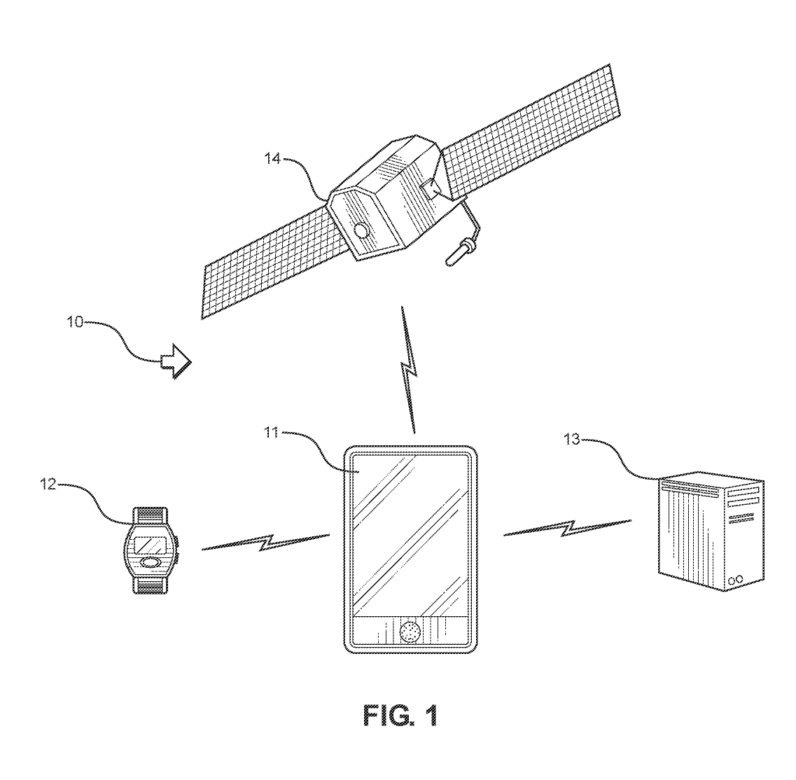

Referring now to FIG. 1, there is shown view of one embodiment of the emergency monitoring system in accordance to the present invention. The system 10 provides an emergency monitoring system that enables a user to communicate information to remote locations in the event assistance is required and documented audiovisual information is captured and recorded. The system 10 comprises an electronic device 11, such as a smartphone, tablet, or other similar device that is in communication with a wearable device 12 and a remote storage device 13. The electronic device 11 includes an audiovisual recording mechanism configured to capture audiovisual data and a global positioning system (GPS) receiver configured to receive a GPS signal from one or more satellites 14 for determining the location of the electronic device 11.

The electronic device 11 further includes a wireless transceiver configured to communicate the audiovisual data and location information to a remote storage device 13. The remote storage device 13 includes any type of communication networks, any server apparatus, or cloud network.

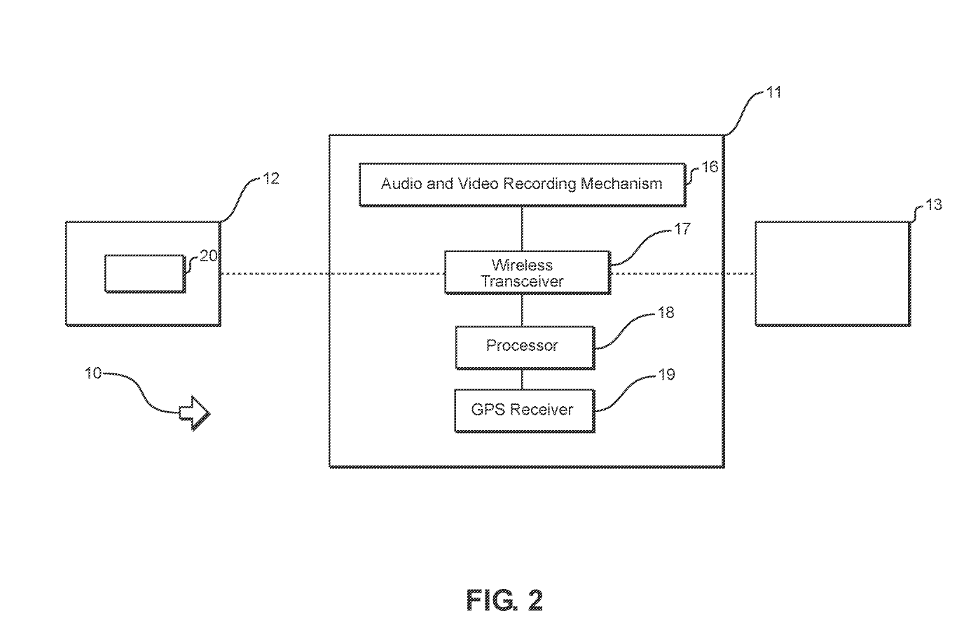

Referring now to FIG. 2, there is a shown block diagram of one embodiment of an electronic device in accordance with an exemplary embodiment of the present invention. The audiovisual recording mechanism 16 of the electronic device 11 includes, but is not limited to, a camera and microphone combination. In one embodiment, the audiovisual recording mechanism 16 is in electrical communication with a processor 18 that coordinates the actions of the electronic device 11.

The electronic device 11 may be powered via an integral power source, such as a rechargeable battery disposed therein, or by an external power source that is in electronic communication with the electronic device 11. The wireless transceiver 17 is operably connected to the processor 18 and is configured to receive audiovisual information and location data from at least the audiovisual recording mechanism 16 or GPS receiver 19. The processor 18 is configured to have the wireless transceiver 17 communicate the captured audiovisual information and location data to the remote server 13, wherein the audiovisual information and location data is stored on the remote server 13. The remote server 13 may include any type of non-transitory computer-readable medium or other storage device. Some non-limiting examples of non-transitory computer-readable media include CDs, DVDs, BLU-RAY, flash memory, and hard disk drives. This further includes storage on a plurality of remote servers 13 or cloud storage. Upon receiving the audiovisual information and location data, the remote server 13 stores the information such that it remains accessible to the user or other authorized persons. In one embodiment, the remote server 13 may encrypt the audiovisual information and location data, allowing access only to authorized personnel.

In some embodiments, the wearable device 12 is a wristband adapted to be secured about a user's wrist. In other embodiments, the wearable device 12 includes, but is not limited to, a bracelet, keychain, or necklace securable to a user's belt loop, purse, neck, or other similar area. In some embodiments, the wearable device 12 includes an activation button 20, wherein actuation of the activation 20 initiates the audiovisual recording mechanism 16 of the electronic device 11 to begin recording. In one embodiment, the wearable device 12 further comprises a voice activatable module, such as a microphone, wherein activation of the voice activatable module causes a command to be communicated to the electronic device 11. Further, the GPS receiver 19 of the electronic device 11 is also recorded and updated during the duration of the recording of the audiovisual recording mechanism 16.

In an alternative embodiment, the electronic device 11 is in wireless communication with a remote server 13 that is accessible by emergency service personal, such as the police and fire department. The actuation of the activation button 20 of the wearable device 12 causes an emergency message, such as an SMS text message, to be sent to the remote server 13.

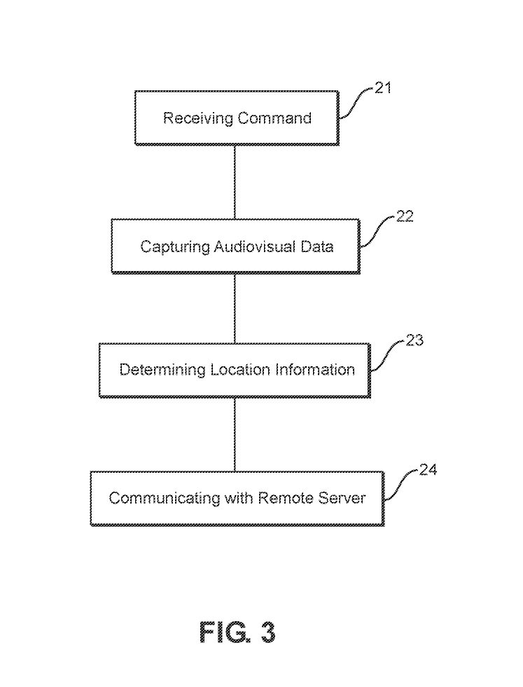

Referring now to FIG. 3, there is a shown exemplary flowchart of one process used to implement the emergency monitoring system and method provided by the present invention. The electronic device comprises an audiovisual recording mechanism, a memory, a processor, a logic stored in the memory that, when executed by the processor, causes the electronic device to perform a method comprising the steps of: capturing audiovisual data via an audiovisual recording mechanism 22 of an electronic device when the command is received 21 from the wearable device; determining the location information of the electronic device via a global positioning system (GPS) receiver 23 of the electronic device when the command is received from the wearable device; and communicating the audiovisual data and location information to a remote server 24.

In an exemplary use of one embodiment the emergency monitoring system, a user wears a bracelet embodiment of the wearable device, and the user carries the electronic device in a purse. The user witnesses an emergency situation and presses the activation button of the wearable device, causing the command to be sent from the wearable device and received 21 by to the electronic device. The command causes the audiovisual recording mechanism and GPS receiver of the electronic to capture audiovisual and location data 22, 23, respectfully. The audiovisual data and location information may be stored, in transitory or non-transitory memory, on the electronic device. The audiovisual data and location information is communicated to a remote storage server 24 that includes any type of communication networks, storage devices, any server apparatus, or cloud network via a wireless transceiver, wherein the audiovisual data and location information is stored therein. The remote server may be owned, operated, or otherwise accessible by any emergency service organization or personal. In another embodiment, the audiovisual data and location information is streamed to the remote server in real time, or with minimal delay. The remote server may include preselected individuals and devices, wherein the audiovisual data and location information is further communicated thereto. Overall, the present invention provides the user additional time to deal with the emergency situation by not requiring the physical handling of the electric device, while still capturing relevant information.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An emergency safety monitoring system comprising:
a wearable device including a wireless transceiver;
the wearable device configured to transmit a command to an electronic device;
the electronic device including an audiovisual recording mechanism, a memory, a processor, a logic stored in the memory that, when executed by the processor, causes the electronic device to perform a method, the method comprising the steps of:
capturing audiovisual data via the audiovisual recording mechanism when the command is received from the wearable device;
determining the location information of the electronic device via a global positioning system receiver when the command is received from the wearable device;
communicating the audiovisual data and location information to a remote storage device.

2. The emergency safety monitoring system of claim 1, wherein:
the audiovisual data stored on the remote memory storage device is encrypted.

3. The emergency safety monitoring system of claim 1, wherein:
the audiovisual data is stored on the electronic device.

4. The emergency safety monitoring system of claim 1, wherein:
the wearable device further comprises an actuatable button;
wherein actuation of the activation button causes a command to be communicated to the electronic device.

5. The emergency safety monitoring system of claim 1, wherein:
the wearable device further comprises a voice activatable module;
wherein activation of the voice activatable module causes a command to be communicated to the electronic device.

6. The emergency safety monitoring system of claim 1, wherein:
the wearable device is a bracelet.

7. The emergency safety monitoring system of claim 1, wherein:
the electronic device will automatically communicate the data and the image data to the remote memory storage device after a certain amount of time.

8. An emergency safety monitoring system comprising:
an electronic device configured to receive a command from a wearable device;
the electronic device including an audiovisual recording mechanism, a global positioning system receiver, a memory, a processor, a logic stored in the memory that, when executed by the processor, causes the electronic device to perform a method, the method comprising the steps of:
capturing audiovisual data via the audiovisual recording mechanism when the command is received from the wearable device;
determining the location information of the electronic device via a global positioning system receiver when the command is received from the wearable device;
communicating the audiovisual data and location information to a remote storage device.

9. The emergency safety monitoring system of claim 8, wherein:
the audiovisual data stored on the remote memory storage device is encrypted.

10. The emergency safety monitoring system of claim 8, wherein:
the audiovisual data is stored on the electronic device.

11. The emergency safety monitoring system of claim 8, wherein:
the electronic device will automatically communicate the data and the image data to the remote memory storage device after a certain amount of time.

12. A computer implement method comprising the steps of:
capturing audiovisual data via an audiovisual recording mechanism of an electronic device when the command is received from the wearable device;
determining the location information of the electronic device via a global positioning system receiver of the electronic device when the command is received from the wearable device;
communicating the audiovisual data and location information to a remote storage device.
